(19) United States
(12) Patent Application Publication
(10) Pub. No.: US 2014/0327583 A1
(43) Pub. Date: Nov. 6, 2014

(54) RANGE EXTENDING SYSTEM FOR SUBTERRANEAN RF DEVICES

(71) Applicants: Travis Sparks, Flint, TX (US); Michael L. Gregory, Hallesville, TX (US); Jonathan Scott Ratliff, Red Oak, TX (US)

(72) Inventors: Travis Sparks, Flint, TX (US); Michael L. Gregory, Hallesville, TX (US); Jonathan Scott Ratliff, Red Oak, TX (US)

(21) Appl. No.: 13/875,031

(22) Filed: May 1, 2013

(51) Int. Cl. H01Q 1/04

(52) U.S. Cl. CPC H01Q 1/04
USPC 343/702; 343/719

(57) ABSTRACT

Embodiments of the invention comprise a system for improving subterranean RF signal propagation. Embodiments comprise a redirecting antenna element which includes a redirecting conductive arrangement, a feed point, and a receiving antenna element which includes at least one or more planes. The redirecting antenna element and receiving antenna are arranged to create a redirection of the energy produced by the existing RF device. Further, the proposed invention will cause the radio signal from the original RF device to be redirected to an elliptical propagation pattern. This new elliptical propagation pattern will be elongated from the original RF propagation pattern along an axis perpendicular to the neighboring streets and thus cause it to be intersected by drive-by reading systems at a greater distance when they intersect this axis.

### CROSS REFERENCES AND PRIORITY CLAIMS

The present application claims the benefit of Provisional U.S. Application No. 61/643,003, dated May 4, 2012, entitled “RANGE EXTENDING SYSTEM FOR SUBTERRANEAN RF DEVICES,” the disclosure of which is incorporated by reference.

### BACKGROUND

Signal attenuation in subterranean RF devices presents a problem to signal transmission. Subterranean RF Devices such as Automatic Meter Reading (AMR), Advanced Metering Infrastructure (AMI) devices, SCADA, WiFi and other similar RF devices are routinely installed in underground pits, vaults, or other subterranean enclosures. A large number of these devices have intrical antennas and as a result, the RF broadcast signal originates at or below ground level. These RF systems suffer a natural attenuation of the RF signal they use to communicate with by the very nature of being installed at or below ground level.

Such ground-level, or below ground level RF systems suffer from the lack of line-of-sight path for the RF signals to reach the reading equipment, and from the attenuating and scattering effects of the enclosure itself, soil, pavement, and concrete. Signal attenuation can be further compounded by seasonal changes in vegetation growth and the moisture content of the soil.

Such subterranean environments shape the RF propagation pattern of systems such as water meters, gas meters, electric meters or any other data gathering, signaling, or consumption measurement systems installed at or below ground level which use RF signals to broadcast data. The inherent scattering and mixing of different RF polarities from this subterranean environment further increases the unpredictable nature of the RF coverage area. The result is that RF systems deployed in subterranean environments suffer from efficiency losses and, as a result, inconsistent and often inadequate read distances.

Attempts have been made to solve the problem of signal attenuation in subterranean RF devices. For example, some systems use RF transparent lids mounted at or on the access way or lid of the subterranean enclosure. Some of these systems have employed higher RF transmitting power levels to increase the range at the cost of decreased battery life, or larger more expensive batteries. Some systems have extended their coverage by installing localized collectors that receive the RF signals over short distances and forward the data over wired communication network, or retransmitted via wireless network. The inherent compromise of RF systems that are installed at or below ground level and required to be low powered because of battery cost and longevity result in hampered performance, ranges that vary unpredictably, and performance that varies from one season to the next depending on vegetation. Therefore, a need exists for a system capable of providing effecting RF transmission in subterranean devices.

### SUMMARY

Embodiments of the invention are directed towards solving the need for a system capable of providing effective RF transmission in subterranean devices. It is an object of the present invention to provide a device that will modify the RF propagation pattern of a typical subterranean RF device to improve its range. The design of embodiments of the invention are such as to create a redirection of the energy produced by the existing subterranean RF device. Further, the proposed invention will cause an omnidirectional pattern from the original RF device to be redirected to an elliptical propagation pattern. This new elliptical propagation pattern will be elongated from the original RF propagation pattern along an axis perpendicular to the neighboring streets and thus cause it to be intersected by both mobile and fixed base reading systems at a greater distance when they intersect this axis.

The existing grid arrangements of apartment and housing developments and the existing arrangement of utilities being delivered to a building perpendicular to the streets will provide effective orientation for the present invention to offer advantage by nature of the elliptical RF propagation pattern.

The present invention, by varying the orientation during installation, can efficiently direct RF energy to stationary collection devices not oriented perpendicular to the streets, or those oriented perpendicular across parallel streets in a neighborhood, as well as improve the effective reading range of vehicle mounted reading equipment and walk-by reading systems. The result of configuration will allow operators to reduce the distance traveled by mobile collection systems and reduce the number of collectors or repeaters required in fixed base systems. For systems that are two-way in nature, even greater savings can be maximized on infrastructure requirements, as the effect of the technology of the present invention is bidirectional in nature.

### BRIEF DESCRIPTION OF THE DRAWINGS

These and other features, aspects and advantages of embodiments of the invention will become better understood with regard to the following description, appended claims, and accompanying drawings where:

FIG. 1 is an isometric view of an existing residential underground meter installation utility.

FIG. 2 is a top view of an exemplary representation of RF signal propagation of the residential underground meter installation utility in FIG. 1.

FIG. 3 is a top view of a range extending system for subterranean RF devices of an embodiment of the invention.

FIG. 4 is an isometric view of a range extending system for subterranean RF devices of the embodiment of FIG. 3.

FIG. 5 is a bottom view of a range extending system for subterranean RF devices of the embodiment of FIG. 3.

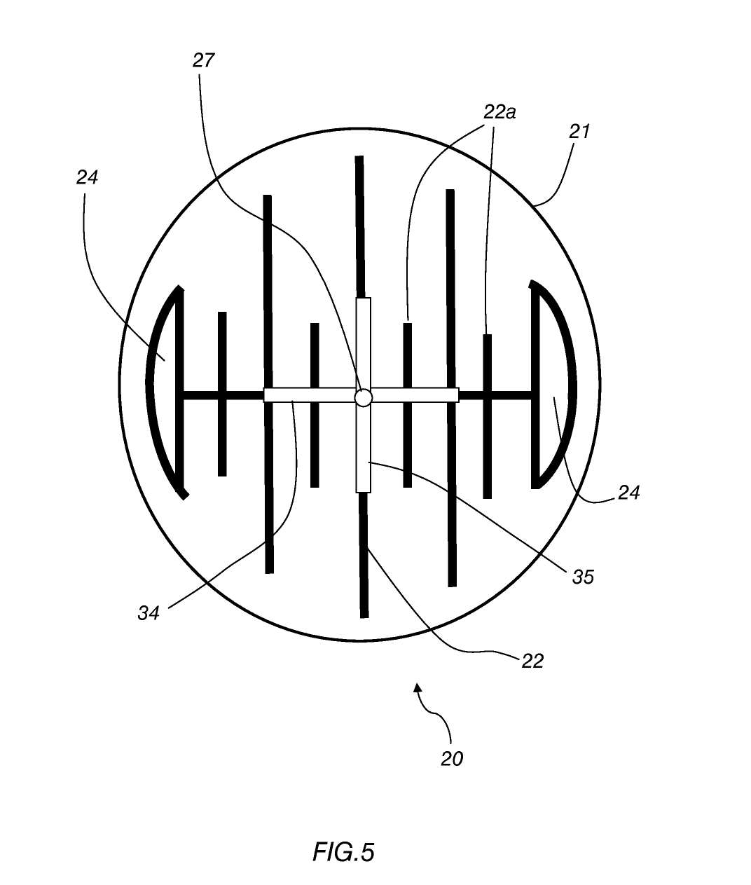

FIG. 6 is a top view showing placement of the range extending system for subterranean RF devices on an uppermost lid of the embodiment of FIG. 3.

FIG. 7 is a side sectional view showing placement of the range extending system for subterranean RF devices on an uppermost lid of the embodiment of FIG. 3.

FIG. 8 is a side sectional view showing placement of the range extending system for subterranean RF devices on an uppermost lid and the interaction with an RF AMR device of the embodiment of FIG. 3.

FIG. 9 is a top view of an exemplary representation of RF signal propagation of the range extending system for subterranean RF devices of the embodiment of FIG. 3.

FIG. 10 is an isometric view of a range extending system for subterranean RF devices of an alternate embodiment.

### DESCRIPTION

Overview

Embodiments of the invention solve the need for a system capable of providing effective RF transmission in subterranean devices. Embodiments of the invention may be implemented on currently existing installations to improve subterranean RF transmission and reception.

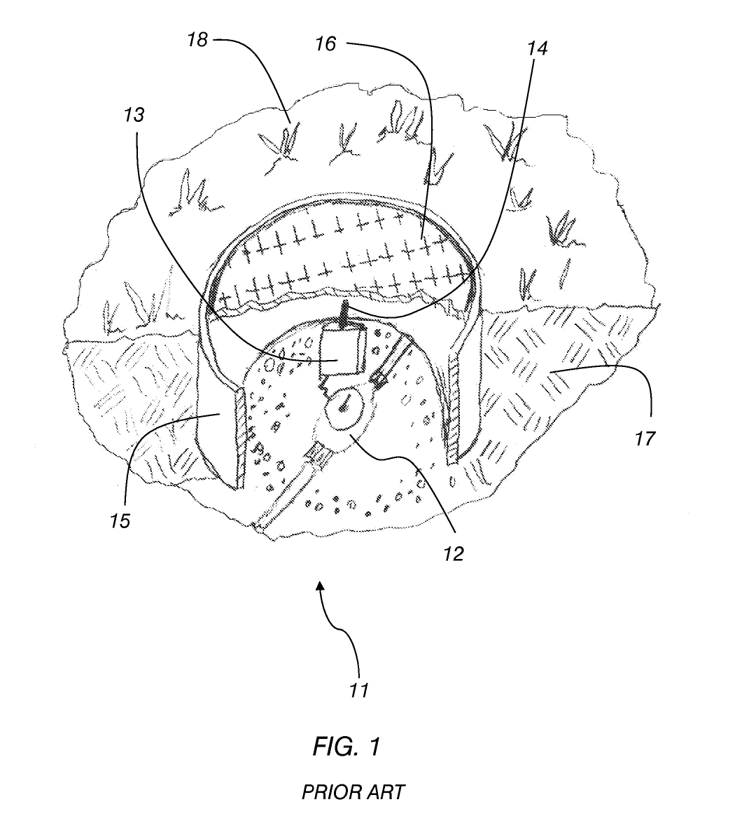

FIG. 1 shows an isometric view of a currently existing residential underground meter installation utility 11. As illustrated in FIG. 1, the residential underground meter installation utility 11 includes a water utility meter 12, an RF type AMR device 13, an RF antenna 14, an underground enclosure 15, and a lid 16. The lid 16 is commonly made of plastic, resin, metal, or concrete. The first impediment to the propagation of RF energy is the underground enclosure 15 itself. Absorption and a attenuation of RF energy is greatly increased by: the surrounding soil, shown as 17 in FIG. 1; and grass and other vegetation shown as 18 in FIG. 1. The RF energy that does radiate out of the containment effected by the underground environment can be further blocked and scattered by obstructions such as shrubs, foliage, and vegetation, sidewalks, automobiles, houses or buildings. It is also common for subterranean enclosures to flood with water and become filled with sediments further attenuating RF energy.

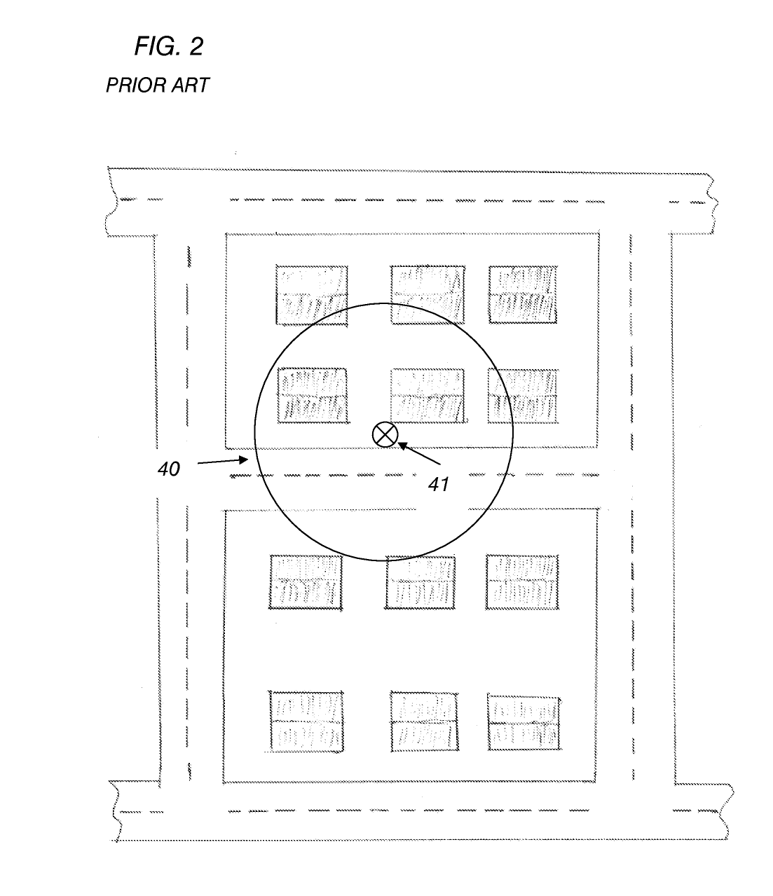

FIG. 2 shows a top view of an exemplary representation of RF signal propagation of the residential underground meter installation utility 11. The range and direction of such a device is shown as 40 in FIG. 2. The location of the AMR device 13 is shown at 41 in FIG. 2.

Embodiments of the invention may be used on such installations to improve subterranean RF reception and transmission and to overcome the signal attenuation problems of such installations. The following detailed description illustrates the preferred embodiment of the invention by way of example. This description will clearly enable one skilled in the art to make and use the invention, and will set forth the best mode of doing so. The embodiments listed herein are not intended to limit the scope of the invention. Several alternative embodiments are set forth, and it is contemplated that other permutations, arrangements, adaptations, uses, and variations of the invention are possible.

### DETAILED DESCRIPTION

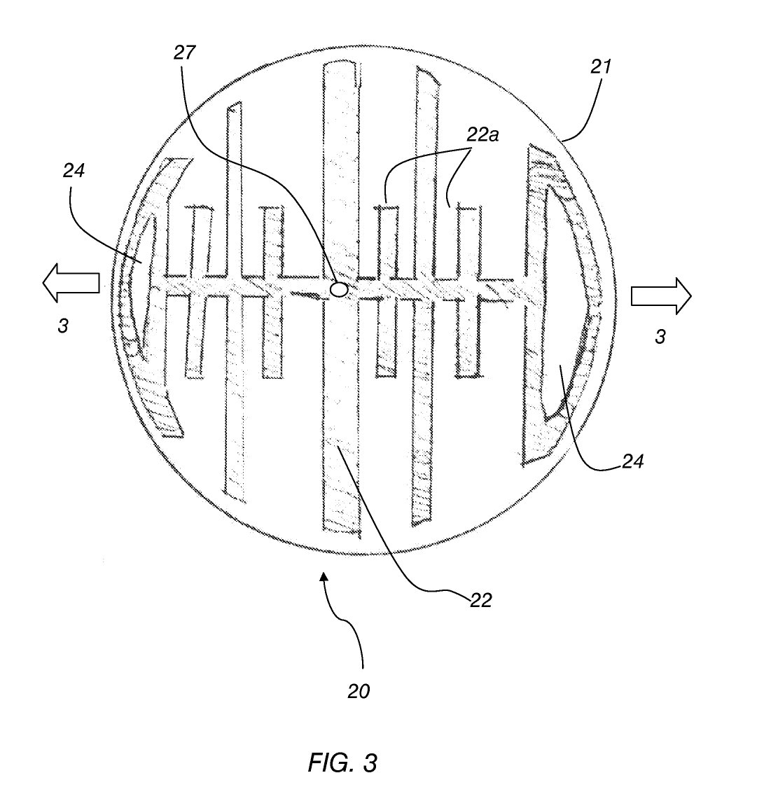

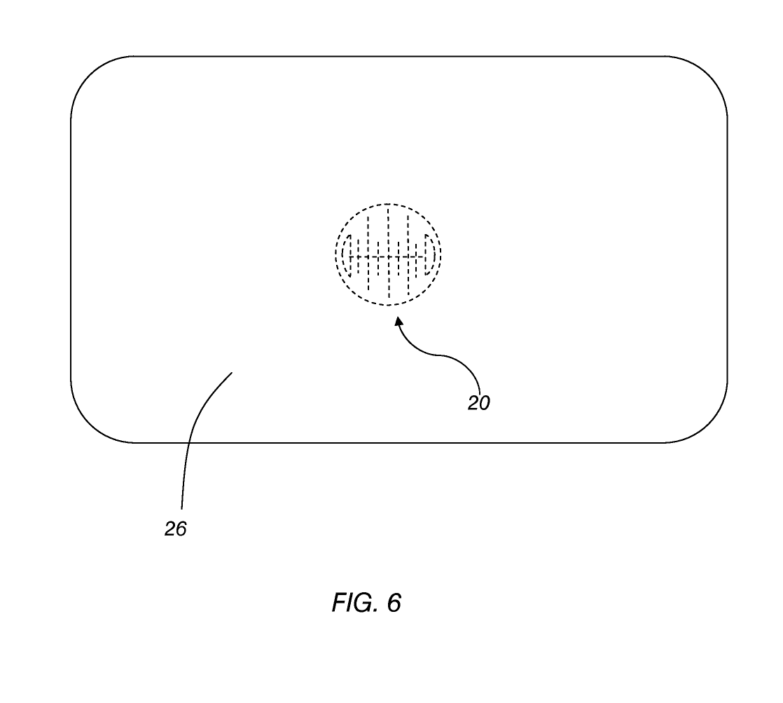

FIG. 3 shows a top view of a range extending system for subterranean RF devices 20 of the preferred embodiment. According to the embodiment, a redirecting antenna element 21 is located on an uppermost lid 26, as shown in FIGS. 6-8. The uppermost lid 26 is constructed of a solid resilient material (such as a hard plastic) shaped to cover an underground enclosure 25. The underground enclosure 25 houses a water utility meter 70 and RF AMR device 80. The redirecting antenna element 21 has a redirecting conductive arrangement 22, which serves as a radiating antenna. The geometry of the redirecting conductive arrangement 22 can be fashioned by those skilled in the art in such to be a semi-directional multi-band, multi-element antenna, as shown in FIG. 3. The redirecting conductive arrangement 22 will be arranged in such a manner as to provide an elliptical radiation pattern with a portion of the RF AMR device's 80 RF energy directed radially outward along the axis of the redirecting conductive arrangement 22, shown by the arrows labeled 3 in FIG. 3. The redirecting conductive arrangement 22 may have multiple extending redirecting radiating elements 22a as shown in FIG. 2. The redirecting radiating elements 22a provide RF gain to compensate for losses incurred in the redirection of the RF energy. As shown in FIG. 3, cavity and notch filters 24 may be employed in the geometry of the redirecting conductive arrangement 22 to control harmonics, parasitic resonances, and provide a mechanism for controlling the bandwidth of intermediate frequencies. The redirecting antenna element 21 has a feed point 27, as shown in FIG. 3.

The redirecting radiating elements 22a may be tuned to single or multiple frequencies to encompass those frequencies required by the AMR device being enhanced. The redirecting radiating elements 22a may be of differing lengths to effect a multiband antenna, as shown in FIG. 3. Typical but not exclusive frequencies employed by AMR systems may be 2.4 GHz, 915 MHz, or 400 MHz band frequencies. According to the preferred embodiment, the redirecting antenna element 21 is constructed of PCB board, with the redirecting conducting arrangement 22 and redirecting radiating elements 22a as etched or screened copper.

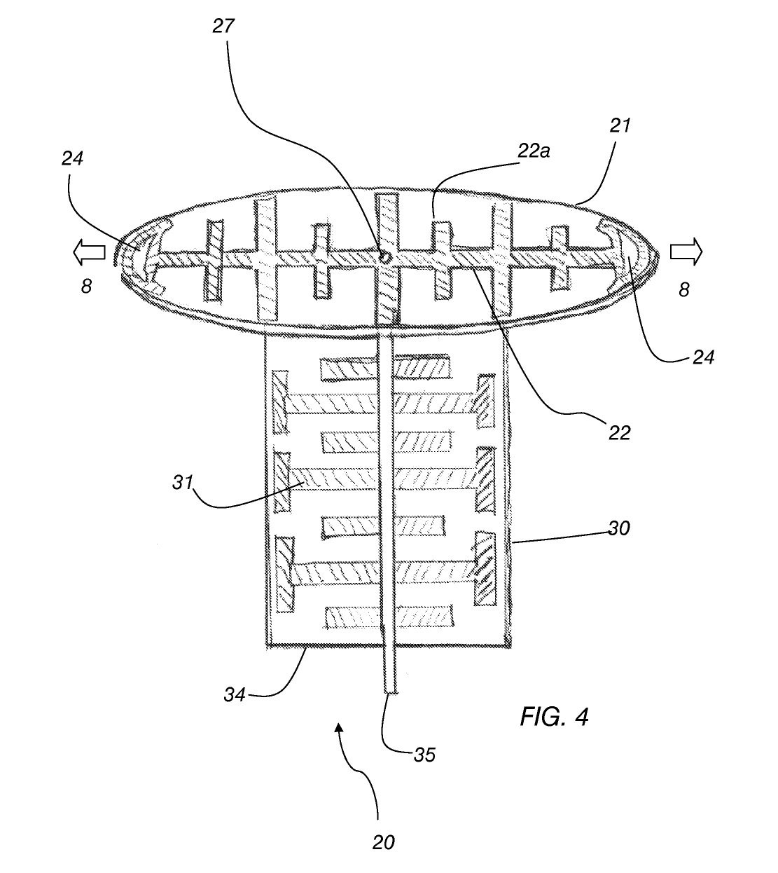

FIG. 4 shows an isometric view of a range extending system for subterranean RF devices 20 of the preferred embodiment. A receiving antenna element 30 is mounted approximately perpendicular to the redirecting antenna element 21, as shown in FIG. 4. The receiving antenna element 30 collects the RF energy transmitted by the existing RF AMR device 80 in the underground enclosure 25. The receiving antenna element 30 is composed of one or more planes 34, 35, as shown in FIGS. 3-4. The planes 34, 35 may extend in free space in all three dimensions so as to collect as much of the RF energy scattered by the original RF AMR device 80 as possible in the underground enclosure 25. The receiving antenna element 30 comprises one or more collection elements 31. The collection elements 31 are conductive members and provide for efficient collection of RF energy regardless of the polarity of the radiating source. The RF energy radiated by the receiving antenna element 31 will mix with the RF energy coming from the existing RF AMR device 80 as well as redirect the RF energy along the radial axis as shown by 8 in FIG. 4. The receiving antenna element 30 communicates with the redirecting antenna element 21 through an impedance matched connection, at the feed point 27. In the preferred embodiment, the impedance is 50 ohms.

In the preferred embodiment, the receiving antenna element 30 and planes 34, 35 are constructed as etched PCB board. The collection elements 31 are constructed as an etched or screened copper pattern on common PCB substrate bonded to or embedded in plastic.

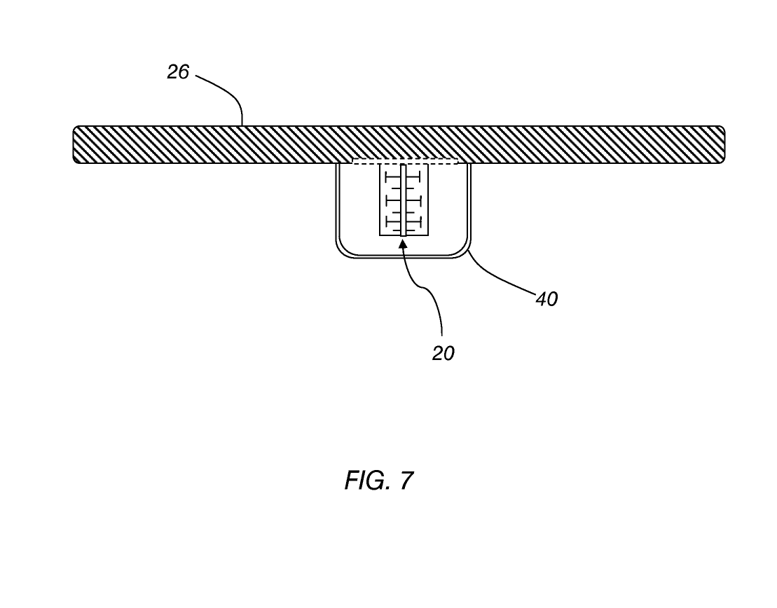

In the preferred embodiment, the range extending system for subterranean RF devices 20 is integrated into the uppermost lid 26 as shown in FIGS. 6, 7. As illustrated in FIG. 7, the redirecting antenna element 21 is integrated such that it is parallel with the uppermost lid 26, with the receiving antenna element 30 extending below the uppermost lid 26. A protective case 40 encloses the range extending system for subterranean RF devices 20, as shown in FIG. 7. The range extending system for subterranean RF devices 20 may also be attached to, mounted on, or mounted in, or embedded into the uppermost lid 26. The uppermost lid 26 may be constructed of a number of resilient materials, such as metal or plastic, for example.

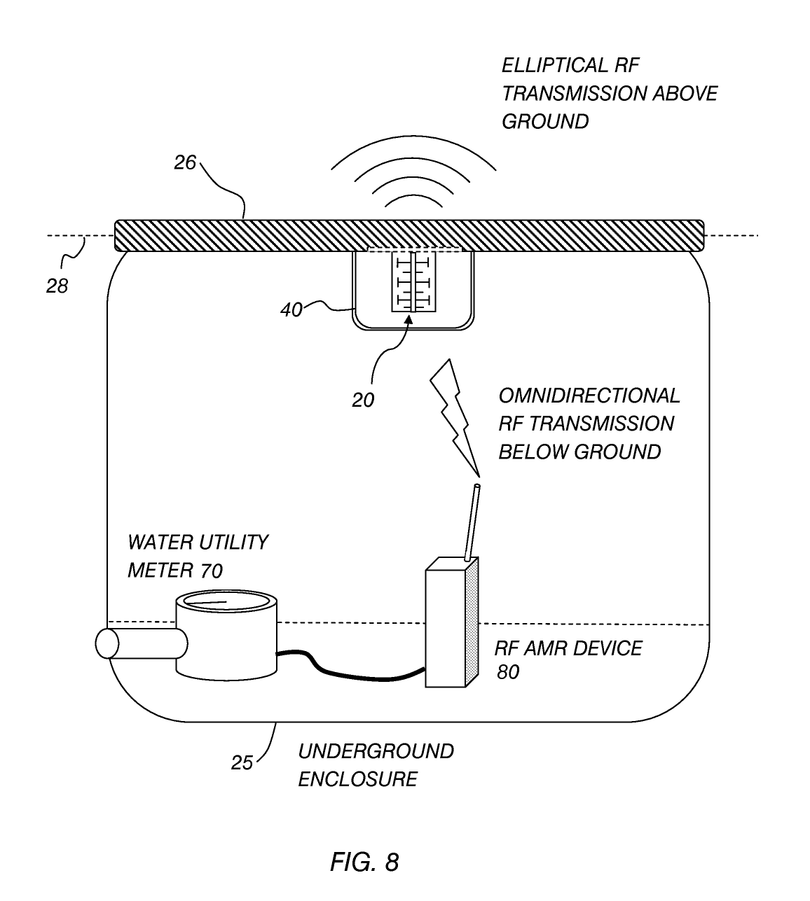

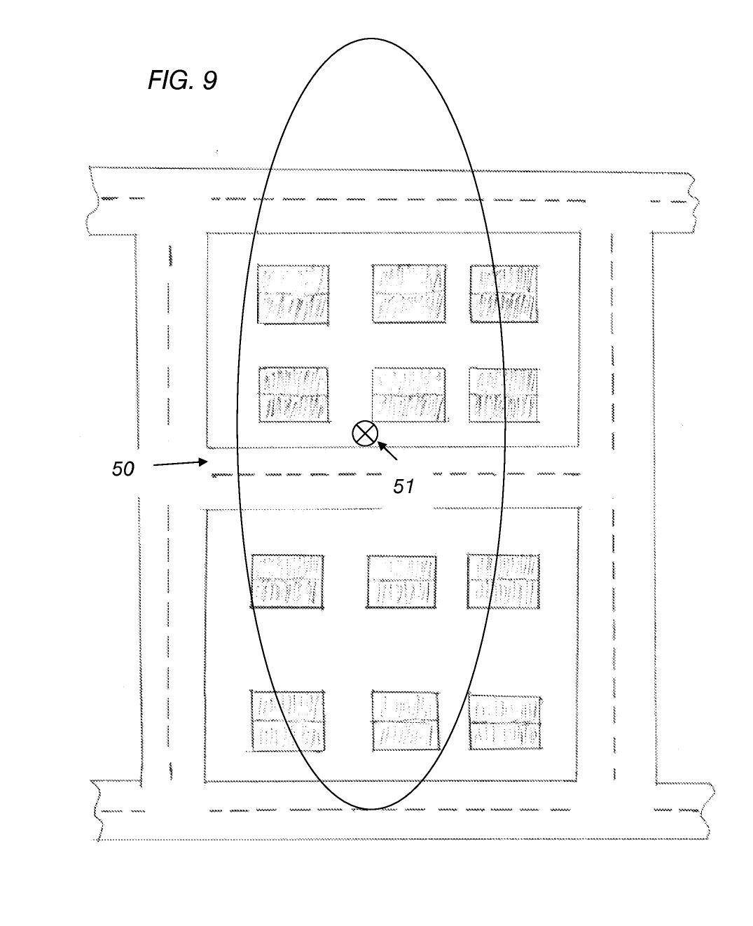

FIG. 8 shows implementation of the range extending system for subterranean RF devices 20 of the preferred embodiment. In accordance with FIG. 8, the water meter 70 and RF AMR device 80 exist in an underground enclosure 25. The water meter 70 communicates a reading to the RF AMR device 80. The RF AMR device 80 then transmits an RF signal, which is received by the receiving antenna element 30. The signal passes from the receiving antenna element 30 through the feed point 27 to the redirecting antenna element 21. The redirecting antenna element 21 then propagates the RF signal radially outward from the ground 28 in an elliptical propagation pattern, in accordance with FIG. 9.

FIG. 9 shows a top view of an exemplary representation of RF signal propagation of the range extending system for subterranean RF devices 20. An exemplary representation of the absorbed and redirected RF propagation pattern and thus the modified range of the preferred embodiment is shown as 50 in FIG. 9. The location of the range extending system for subterranean RF devices 20 is shown as 51 in FIG. 9. As illustrated in FIG. 9, the RF propagation is reduced from side-to-side (as compared to the propagation pattern in FIG. 2) due to absorption of RF energy by the receiving antenna element 30. The energy is redirected out opposite ends and blended with the original AMR device RF propagation to form the modified propagation pattern 50 shown in FIG. 9. The novel re-orientation of the RF propagation pattern 50 shown in

FIG. 9 shows how range is increased by projecting more RF energy perpendicular across parallel streets in a neighborhood to improve the effective reading range.

Alternatives

Although the invention has been set forth in the previously described best mode, other alternative embodiments are possible. For example, other embodiments may have its elements implemented with the following: conductive ink or other substance printed on a nonconductive substrate, a stamped or formed metal or metallic element such as copper, brass, nickel, etc bonded to or embedded in a plastic, or a conductive composite element such as carbon impregnated fiber bonded to or embedded in a plastic, or a metallic plating on or embedded in a plastic or other nonmetallic substance. To ensure weatherproofing embodiments of the present invention in multiple embodiments may be embedded in a potting compound, plastic enclosure, over molded plastic, or other such combination means as to provide protection.

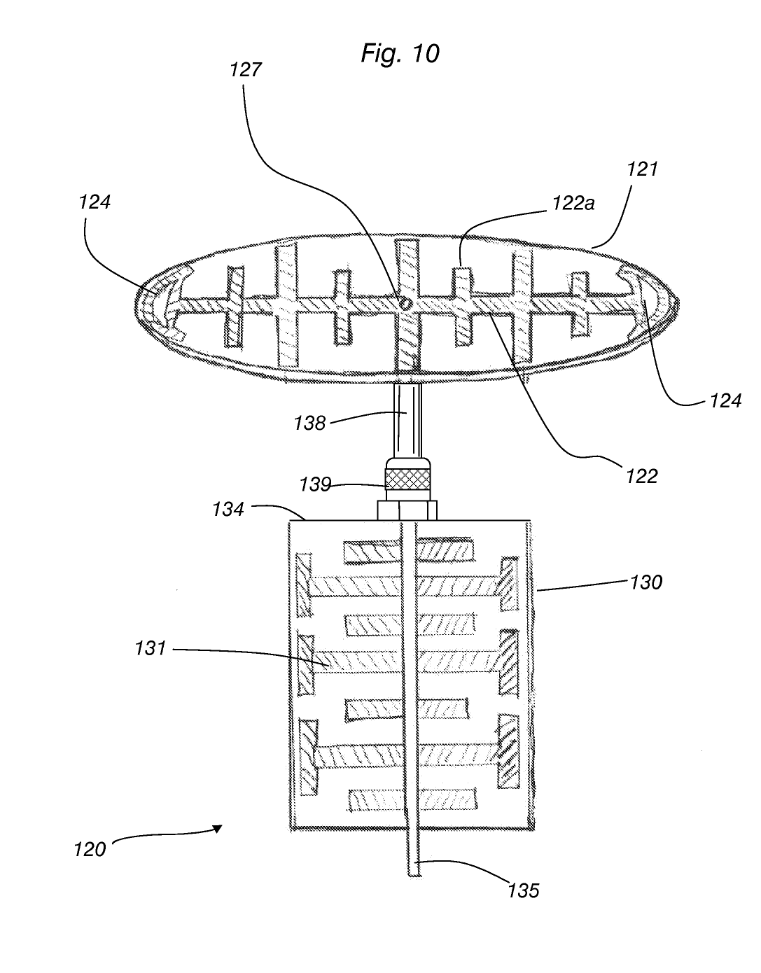

FIG. 10 shows an alternate embodiment of a range extending system for subterranean RF devices 120, comprising a redirecting antenna element 121, redirecting conductive arrangement 122, extending redirecting radiating elements 122a, a feed point 127, a receiving antenna element 130, collection elements 131, planes 134, 135, a cable 138, and coupler 139. In the embodiment, the redirecting antenna element 121 and receiving antenna element 130 are separated. The cable 138 extends from the feed point 127 to the coupler 139, which is joined to the receiving antenna element 130. The coupler 139 and feed point 127 are impedance matched at 50 ohms. The cable 138 is a RG-6 coaxial cable with impedance of 50 ohms. However, other cables and impedances may be implemented.

Although the exemplary embodiment described herein is a parasitic resonator that does not require a power source, alternate embodiments may include asset elements such as discrete or integrated filters, chokes, capacitors, and other such resonating, filtering, and tuning devices as required by the RF signals involved.

Alternate embodiments may include passive or active RF amplifiers, gain multiplying elements, active filters, active attenuators, and other powered and passive devices as may be required by the nature of the RF signals being redirected and to maximize the efficiency thereof.

Alternate embodiments may include active and powered components such as a RF receiver capable of receiving the transmission from the original subterranean RF device and retransmitting the intelligence in the previously proposed elliptical RF propagation pattern.

Alternate embodiments may include a common network communications device such as a cellular modem, two way pager modem, WiFi modem, proprietary RF network or other such devices which are designed to utilize existing private or publicly available communications networks. The native protocol and RF format of the original subterranean RF device can be received and translated to be compatible with the retransmitted protocol and RF format.

Alternate embodiments of the present invention that require power may receive such power from batteries that are rechargeable, replaceable, or those that are more permanent in nature such as lithium cells. Power may be directed from the building or dwelling that the utility provides services to by means of wires connected to common power sources. Alternative sources of power may include a wind, solar, geothermal, or any other means a common art provides.

Alternate embodiments may be housed in such a manner that allow for generic and universal mounting in all of the typical plastic and metal covers and lids common to underground utility enclosures. Further, these housings would also provide versatile and universal mounting bracket and other facilities to allow for the mounting of several common subterranean RF devices, thus assuring proper placement as well as improved tuning with the present invention.

Alternate embodiments may be incorporated into rectangular lids or doors and may be constructed in such a manner as to provide a visual indication of RF propagation pattern alignment by means of permanent markings on the top exterior of the embodiment.

Alternate embodiments of the present invention that are circular in shape may also provide markings to assist the installer in the proper orientation of the system.

Differing combinations and permutations of the embodiments set forth are contemplated by the current invention. Additionally, all functional equivalents of materials used and means of attachment of elements are contemplated by the current invention. Therefore, the spirit and scope of the appended claims should not be limited to the descriptions of the preferred versions and alternate embodiments set forth herein.

What is claimed is:

1. A range extending system for subterranean radio frequency devices for improving signal propagation received from a radio frequency device enclosed in a subterranean enclosure, comprising:
a. an uppermost lid enclosing said subterranean enclosure;
b. a redirecting antenna element located at said uppermost lid, comprising a redirecting conductive arrangement;
c. a receiving antenna element mounted approximately perpendicular to said redirecting antenna element, comprising one or more planes;
d. collection elements located on said planes;
e. wherein said redirecting conductive arrangement further comprises redirecting radiating elements positioned as a radiating antenna;
f. wherein said collection elements are configured to receive a radio signal from a subterranean radio frequency device located beneath said range extending system for subterranean radio frequency devices and transmits said radio signal to said redirecting radiating elements; and
g. wherein said redirecting radiating elements receives said radio signal from said collection elements and propagates said radio signal above the surface of the ground in an elliptical propagation pattern.

2. The range extending system for subterranean radio frequency devices of claim 1, wherein said redirecting antenna element is embedded in said uppermost lid.

3. The range extending system for subterranean radio frequency devices of claim 2, wherein said receiving antenna element extends below said uppermost lid.

4. The range extending system for subterranean radio frequency devices of claim 1, wherein said redirecting conductive arrangement can be arranged as either: a omnidirectional antenna; or a semi-directional antenna.

5. The range extending system for subterranean radio frequency devices of claim 1, wherein said redirecting conductive arrangement has cavity or notch filters.

6. The range extending system for subterranean radio frequency devices of claim 1, wherein said redirecting antenna element is constructed of PCB board, and said redirecting conducting arrangement and said redirecting radiating elements are constructed of etched or screened copper.

7. The range extending system for subterranean radio frequency devices of claim 1, wherein said receiving element is comprised of two perpendicular planes.

8. The range extending system for subterranean radio frequency devices of claim 7, wherein said collection elements extend across the outer surfaces of said planes.

9. The range extending system for subterranean radio frequency devices of claim 1, wherein said receiving antenna element and said planes are constructed as etched PCB board, and said collection elements are constructed of etched or screened copper.

10. The range extending system for subterranean radio frequency devices of claim 1, wherein said redirecting antenna arrangement and said receiving element are joined at a feed point.

11. The range extending system for subterranean radio frequency devices of claim 10, wherein said redirecting antenna arrangement and said receiving element are impedance matched.

12. The range extending system for subterranean radio frequency devices of claim 11, wherein the impedance of said redirecting antenna arrangement and said receiving element are 50 ohms.

13. The range extending system for subterranean radio frequency devices of claim 1, wherein said range extending system for subterranean radio frequency devices is enclosed by a protective case.

14. The range extending system for subterranean radio frequency devices of claim 1, wherein said protective case is located at a lower side of said uppermost lid.

15. The range extending system for subterranean radio frequency devices of claim 1, wherein said the redirecting antenna element and said receiving antenna element are separated.

16. The range extending system for subterranean radio frequency devices of claim 15, wherein a cable extends from a feed point located on said redirecting antenna element to a coupler attached to said receiving element.

17. The range extending system for subterranean radio frequency devices of claim 16, wherein said coupler and feed point are impedance matched.

18. The range extending system for subterranean radio frequency devices of claim 17, wherein said cable is RG-6 cable with an impedance of 50 ohms.

19. A range extending system for subterranean radio frequency devices for improving signal propagation received from a radio frequency device enclosed in a subterranean enclosure, comprising:
a. an uppermost lid enclosing said subterranean enclosure;
b. a redirecting antenna element located at said uppermost lid, comprising a redirecting conductive arrangement;
c. a receiving antenna element mounted approximately perpendicular to said redirecting antenna element, comprising one or more planes and joined to said redirecting conductive arrangement at a feed point;
d. collection elements located on said planes;
e. wherein said redirecting conductive arrangement further comprises redirecting radiating elements and notch filters positioned as a radiating antenna positioned;
f. wherein said collection elements are configured to receive a radio signal from a subterranean radio frequency device located beneath said range extending system for subterranean radio frequency devices and transmits said radio signal to said redirecting radiating elements; and
g. wherein said redirecting radiating elements receives said radio signal from said collection elements and said redirecting antenna element propagates said radio signal radially outward along an axis of said redirecting conductive arrangement above the surface of the ground in an elliptical propagation pattern.

20. A range extending system for subterranean radio frequency devices for improving signal propagation received from a radio frequency device enclosed in a subterranean enclosure, comprising:
a. an uppermost lid enclosing said subterranean enclosure;
b. a water utility meter located in said subterranean enclosure;
c. a subterranean radio device located in said subterranean enclosure;
d. an uppermost lid enclosing said subterranean enclosure;
e. a redirecting antenna element located at said uppermost lid, comprising a redirecting conductive arrangement;
f. a receiving antenna element mounted approximately perpendicular to said redirecting antenna element, comprising one or more planes;
g. collection elements located on said planes;
h. wherein said redirecting conductive arrangement further comprises redirecting radiating elements positioned as a radiating antenna;
i. wherein said water meter communicates a reading to said subterranean radio frequency device;
j. wherein said subterranean radio frequency device transmits a radio signal, which is received by said receiving antenna element, and passes from said receiving antenna element through a feed point to said redirecting antenna element; and
k. wherein said redirecting antenna element propagates said radio signal radially outward above the surface of the ground in an elliptical propagation pattern.
